(19) United States
(12) Patent Application Publication
(10) Pub. No.: US 2020/0282694 A1
(43) Pub. Date: Sep. 10, 2020

(54) COMPOSITE STRUCTURE AND METHOD OF FORMING THEREOF

(71) Applicant: The Boeing Company, Chicago, IL (US)

(72) Inventors: Christopher Sanders, Snohomish, WA (US); Hyukbong Kwon, Marysville, WA (US); Lisa Carlson, Auburn, WA (US); Khanh Mai Pham, Renton, WA (US)

(21) Appl. No.: 16/295,419

(22) Filed: Mar. 7, 2019

(51) Int. Cl. B32B 5/12; B32B 5/26; B32B 1/00; B29C 53/04

(52) U.S. Cl. CPC B32B 5/12; B32B 5/26; B32B 1/00; B29K 2307/04; B32B 2262/106; B32B 2307/558; B32B 2605/18; B29C 53/04

(57) ABSTRACT

A composite structure that includes a multi-layer laminate including a plurality of layers of material, and at least one crack barrier layer extending within the plurality of layers of material. The multi-layer laminate is folded to define a first web region and a second web region in a face-to-face relationship, and a folded tip region defined between the first web region and the second web region. The at least one crack barrier layer is configured to restrict crack propagation from spreading through the plurality of layers of material in the folded tip region.

### FIELD

The field relates generally to composite structures and, more specifically, to a punch formed blade stringer composite structure having enhanced impact and crack propagation resistance.

### BACKGROUND

The fabrication of multi-layer laminate structures generally includes bonding layers of metallic (e.g., aluminum, titanium, or corrosion resistant steel (CRES)) and/or non-metallic (e.g., carbon fiber, boron, or fiberglass) reinforcement material together with a matrix material to form a rigid structure. The reinforcement material strengthens and stiffens the laminate structure, and the matrix material supports the reinforcement material after a curing process. Multi-layer laminate structures generally have a high strength-to-weight ratio and may be formed in a variety of shapes and sizes. At least some known aircraft components are fabricated from multi-layer laminate structures of non-metallic composite materials such as carbon-fiber-reinforced polymer (CFRP). The composite materials are used in combination with metallic materials, such as aluminum, titanium, and/or steel, to reduce the overall weight of the aircraft. Reducing the overall weight generally contributes to increasing the fuel efficiency of the aircraft. However, common multi-layer laminate structures fabricated from CFRP may be susceptible to damage, such as the formation of micro-cracks and delamination of the structure during service and/or manufacturing thereof. Known damage to such structures may be small and difficult to detect during scheduled maintenance.

This section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

In one aspect, a composite structure includes a multi-layer laminate including a plurality of layers of material, and at least one crack barrier layer extending within the plurality of layers of material. The multi-layer laminate is folded to define a first web region and a second web region in a face-to-face relationship, and a folded tip region defined between the first web region and the second web region. The at least one crack barrier layer is configured to restrict crack propagation from spreading through the plurality of layers of material in the folded tip region.

In another aspect, a stringer includes a web including a first web region, a second web region in a face-to-face relationship with the first web region, and a folded tip region defined between the first and second web regions. A base extends from the web. The base includes a first base region extending from the first web region, and a second base region extending from the second web region. The web and the base are formed from a multi-layer laminate including a plurality of layers of material and at least one crack barrier layer extending within the plurality of layers of material. The at least one crack barrier layer is configured to restrict crack propagation from spreading through the plurality of layers of material in the folded tip region.

In yet another aspect, a method of forming a composite structure includes forming a multi-layer laminate including a plurality of layers of material and at least one crack barrier layer extending within the plurality of layers of material, and folding the multi-layer laminate to define a first web region and a second web region in a face-to-face relationship, and a folded tip region defined between the first web region and the second web region. The method also includes curing the multi-layer laminate, wherein the at least one crack barrier layer is configured to restrict crack propagation from spreading through the plurality of layers of material in the folded tip region.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is an illustration of an example composite structure.

FIG. 2 is an enlarged view of a folded tip region of the composite structure shown in FIG. 1.

FIG. 3 illustrates a series of process steps for forming the composite structure shown in FIG. 1.

Corresponding reference characters indicate corresponding parts throughout the drawings.

### DETAILED DESCRIPTION

The embodiments described herein relate to a punch formed blade stringer composite structure having enhanced impact and crack propagation resistance. The composite structure may be used as a stringer in an aircraft structure. The composite structure is formed from a multi-layer laminate structure that has been folded to define a base, a web, and a folded tip region in the web. At least some known composite manufacturers cut the folded tip region from the web to reduce the risk of cracks or delamination, that initiate in the folded tip region, from propagating to the remainder of the composite structure. In the example embodiment, the multi-layer laminate structure is formed from a plurality of layers of material and a crack barrier layer extending within the plurality of layers of material. The crack barrier layer is positioned to facilitate restricting crack propagation from spreading through the plurality of layers in the folded tip region. In addition, in some embodiments, a detection layer is extended across the folded tip region to facilitate providing impact damage detection. The resulting composite structure has increased strength, a more robust tip resistant to lateral impacts, and barely visible impact damage detection capability.

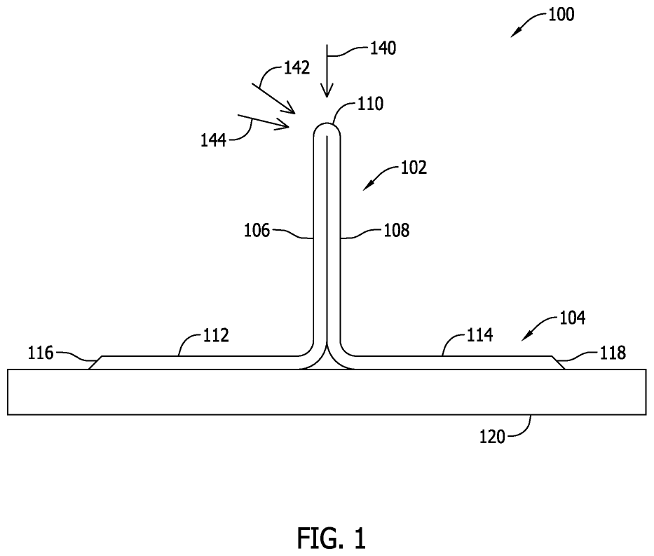

FIG. 1 is an illustration of an example composite structure 100. In the example embodiment, composite structure 100 includes a web 102 and a base 104 extending perpendicularly relative to web 102. Alternatively, web 102 is oriented obliquely relative to base 104. Web 102 includes a first web region 106, a second web region 108 in a face-to-face relationship with first web region 106, and a folded tip region 110 defined between first web region 106 and second web region 108. Base 104 includes a first base region 112 extending from first web region 106, and a second base region 114 extending from second web region 108. First base region 112 includes a first tapered end 116, and second base region 114 includes a second tapered end 118. In some embodiments, composite structure 100 is coupled to a skin panel 120 of an aircraft (not shown), or a separate base charge (not shown), for example. Composite structure 100 facilitates supporting, and increasing the rigidity of, skin panel 120.

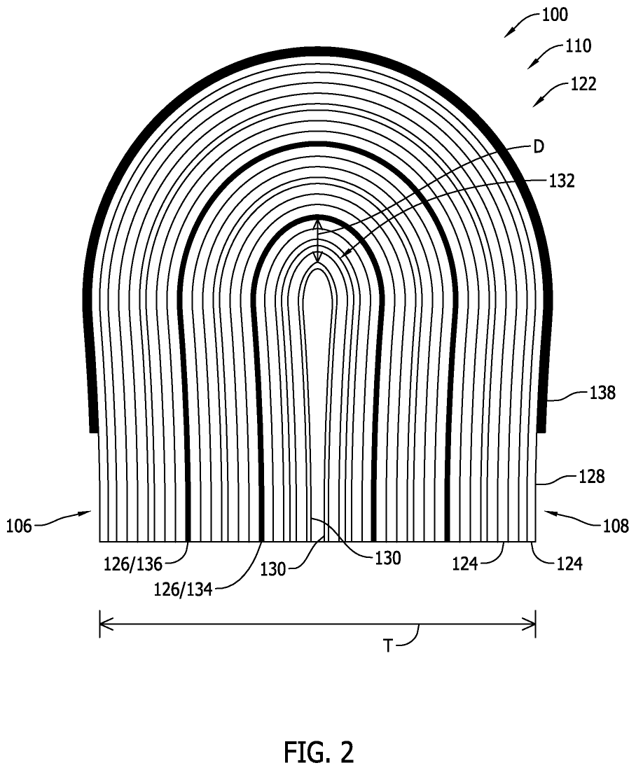

FIG. 2 is an enlarged illustration of folded tip region 110. In the example embodiment, composite structure 100 includes a multi-layer laminate 122 that includes a plurality of layers 124 of material, and at least one crack barrier layer 126 extending within the plurality of layers 124 of material. For example, multi-layer laminate 122 has a first surface 128 and an opposing second surface 130. As will be described in more detail below, multi-layer laminate 122 is folded on itself to form composite structure 100. When folded, first surface 128 is exposed to an ambient environment, and second surface 130 in first web region 106 and in second web region 108 is in face-to-face contact for defining a central core 132.

The at least one crack barrier layer 126 is positioned between outer surface 128 and central core 132. For example, the plurality of layers 124 and crack barrier layer 126 are aligned coterminously in at least one dimension of composite structure 100. More specifically, in one embodiment, layers 124 and crack barrier layer 126 extend from first tapered end 116 to second tapered end 118 such that the at least one crack barrier layer 126 extends throughout folded tip region 110. Alternatively, crack barrier layer 126 has a shorter length and is limited to extending within certain regions of composite structure 100, such as only extending across folded tip region 110. Cracks and/or delamination may initiate within central core 132 and propagate through multi-layer laminate 122. As such, the at least one crack barrier layer 126 is positioned to facilitate restricting crack propagation from spreading through the plurality of layers 124 in folded tip region 110.

In the example embodiment, the at least one crack barrier layer 126 includes a first crack barrier layer 134 and a second crack barrier layer 136 spaced from each other within multi-layer laminate 122. First crack barrier layer 134 is positioned closer to central core 132 than second crack barrier layer 136, and second crack barrier layer 136 is positioned closer to outer surface 128 than first crack barrier layer 134. In addition, first crack barrier layer 134 is positioned closer to central core 132 than to outer surface 128. As such, first crack barrier layer 134 is positioned a predetermined distance D from central core 132. First crack barrier layer 134 restricts crack propagation that may have initiated at central core 132 from spreading beyond predetermined distance D. In one embodiment, the layup location of first crack barrier layer 134 within multi-layer laminate 122 is determined as a function of a threshold thickness of folded tip region 110. As such, a crack (not shown) in multi-layer laminate 122 is restricted from propagating to a length greater than the threshold thickness. The threshold thickness may be about 50 percent, about 40 percent, or about 25 percent of a total thickness T of folded tip region 110. In addition, second crack barrier layer 136 is positioned a distance from first crack barrier layer 134 to provide redundant crack propagation protection in the event crack propagation extends beyond first crack barrier layer 134.

Layers 124 of material and crack barrier layer 126 may be fabricated from any material that enables composite structure 100 to function as described herein. In the example embodiment, layers 124 have a first structural configuration, and crack barrier layer 126 has a second structural configuration different from the first structural configuration. As such, positioning crack barrier layer 126 fabricated from different material than the remainder of layers 124 in multi-layer laminate 122 facilitates forming a discontinuity within multi-layer laminate 122, which facilitates reducing the spread of crack propagation therein.

In addition, layers 124 and crack barrier layer 126 are selected for inclusion in multi-layer laminate 122 based on resin compatibility and thermal expansion considerations. For example, layers 124 and crack barrier layer 126 may be pre-impregnated with resin, which is selected to enable sufficient compatibility for forming multi-layer laminate 122. Layers 124 and crack barrier layer 126 may be impregnated with the same resin or a different resin. In addition, layers 124 and crack barrier layer 126 are selected such that the materials of layers 124 and crack barrier layer 126 have a difference in coefficient of thermal expansion less than a predetermined threshold. The predetermined threshold may be 25 percent, 20 percent, or 10 percent, based on an overall difference in coefficient of thermal expansion values of the material of layers 124 and crack barrier layer 126. As such, layers 124 and crack barrier layer 126 are selected to facilitate forming multi-layer laminate 122 that is structurally sound with a reduced likelihood of delamination from occurring therein. In one embodiment, layers 124 are fabricated from a unidirectional, pre-impregnated, carbon fiber material, and crack barrier layer 126 is fabricated from a bidirectional, pre-impregnated, carbon fiber material. The bidirectional carbon fiber material may be a woven sheet of carbon fiber having fibers oriented in any direction that enables crack barrier layer 126 to function as described herein. For example, the woven sheet may have a 0/90 or 45/45 degree fiber orientation.

In the example embodiment, multi-layer laminate 122 also includes a detection layer 138 extending across folded tip region 110, and across at least a portion of first web region 106 and second web region 108. Detection layer 138 may be fabricated from any material that enables composite structure 100 to function as described herein. In one embodiment, detection layer 138 is fabricated from a glass fiber-reinforced plastic material, also commonly referred to as fiberglass. The composition of detection layer 138 is selected to facilitate visualizing impact damage induced to composite structure 100. For example, fiberglass is generally more brittle than CFRP material such that the application of the same force to fiberglass or CFRP material would be more readily visible and more easily detectable on the fiberglass.

Detection layer 138 also facilitates protecting folded tip region 110 from impact damage. For example, referring to FIG. 1, folded tip region 110 may be susceptible to encountering different types of impacts, such as a first impact 140, a second impact 142, and a third impact 144. First impact 140 is generally axially aligned with web 102, second impact 142 is oriented at about 45 degrees relative to web 102, and third impact 144 is oriented generally laterally to web 102 at about 10 degrees relative to web 102. Without detection layer 138, composite structure 100 having folded tip region 110 is generally capable of sustaining non-critical impact damage from third impact 144 having a force less than a predetermined threshold. The addition of detection layer 138 enables composite structure 100 to be capable of sustaining non-critical impact damage from first impact 140 and second impact 142 having forces less than a predetermined threshold. As such, folded tip region 110 provides robust shear resistance to facilitate withstanding lateral impact damage induced by third impact 144, and detection layer 138 augments the robustness of folded tip region 110 to facilitate withstanding damage induced by first impact 140 or second impact 142. Folded tip region 110 is also resistant to interlaminar buckling.

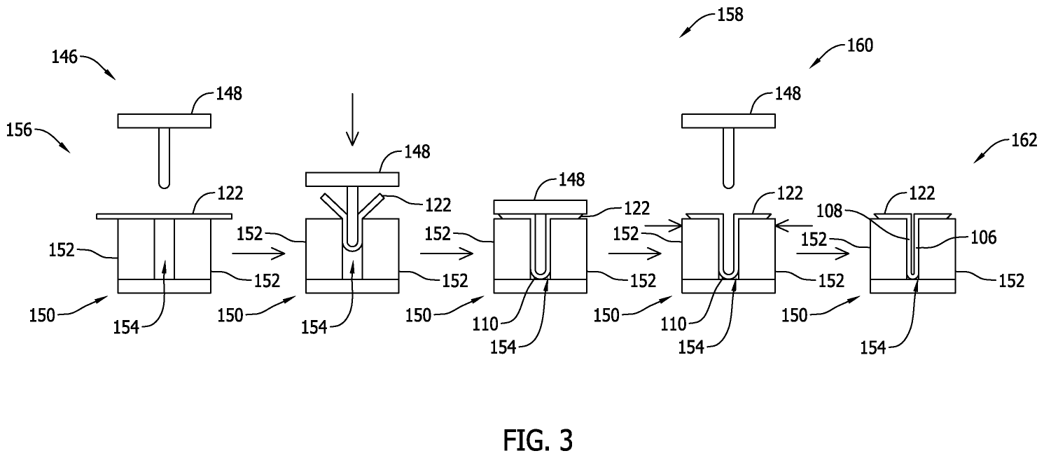

FIG. 3 illustrates a series of process steps for forming composite structure 100 (shown in FIG. 1). In the example embodiment, a punch-forming apparatus 146 is used to form composite structure 100. Punch-forming apparatus 146 includes a punch tool 148 and a die 150. Die 150 includes a pair of die blocks 152 spaced a distance from each other to define a cavity 154 therebetween. Punch tool 148 is translatable relative to die 150, and die blocks 152 are translatable relative to each other to adjust the size of cavity 154.

In the example embodiment, punch tool 148 is initially positioned a distance from die 150. A first process step 156 includes forming multi-layer laminate 122 and positioning multi-layer laminate 122 on die 150. Multi-layer laminate 122 is positioned to extend across cavity 154. A second process step 158 includes translating punch tool 148 towards die 150 to facilitate forcing multi-layer laminate 122 into cavity 154 and initiate folding multi-layer laminate 122 to define folded tip region 110. Once punch tool 148 is fully inserted into cavity 154, punch tool 148 is removed therefrom in a third process step 160 such that only multi-layer laminate 122 remains within cavity 154. A fourth process step 162 includes translating die blocks 152 towards each other to facilitate further folding multi-layer laminate 122 such that first web region 106 and second web region 108 are in a face-to-face relationship. Multi-layer laminate 122 may then be removed from die 150 and cured to form composite structure 100, or cured in-situ within die 150.

Example embodiments of a composite structure folded to define a folded tip region having a crack barrier layer extending therein are described above in detail. Aspects of the composite structure are not limited to the specific embodiments described herein, but rather, components of the composite structure may be used independently and separately from other components described herein. For example, aspects of the composite structure may be included in any composite structure where inhibiting crack propagation from spreading therein is desired.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

1. A composite structure comprising:
a multi-layer laminate comprising:
a plurality of layers of material; and
at least one crack barrier layer extending within the plurality of layers of material,
wherein the multi-layer laminate is folded to define a first web region and a second web region in a face-to-face relationship, and a folded tip region defined between the first web region and the second web region, wherein the at least one crack barrier layer is configured to restrict crack propagation from spreading through the plurality of layers of material in the folded tip region.

2. The composite structure in accordance with claim 1, wherein the plurality of layers of material have a first structural configuration, and the at least one crack barrier layer has a second structural configuration different from the first structural configuration.

3. The composite structure in accordance with claim 1, wherein the composite structure comprises a central core and an outer surface, wherein the at least one crack barrier layer is positioned closer to the central core than to the outer surface.

4. The composite structure in accordance with claim 1, wherein the plurality of layers of material are fabricated from a unidirectional carbon fiber material.

5. The composite structure in accordance with claim 1, wherein the at least one crack barrier layer is fabricated from a bidirectional carbon fiber material.

6. The composite structure in accordance with claim 5, wherein the bidirectional carbon fiber material has a 0/90 or 45/−45 degree fiber orientation.

7. The composite structure in accordance with claim 1, wherein the multi-layer laminate further comprises a detection layer extending across the folded tip region.

8. The composite structure in accordance with claim 1, wherein the at least one crack barrier layer comprises a first crack barrier layer and a second crack barrier layer spaced from each other within the multi-layer laminate.

9. A stringer comprising:
a web comprising:
a first web region;
a second web region in a face-to-face relationship with the first web region; and
a folded tip region defined between the first and second web regions; and
a base extending from the web, the base comprising:
a first base region extending from the first web region; and
a second base region extending from the second web region,
wherein the web and the base are formed from a multi-layer laminate comprising a plurality of layers of material and at least one crack barrier layer extending within the plurality of layers of material, the at least one crack barrier layer configured to restrict crack propagation from spreading through the plurality of layers of material in the folded tip region.

10. The stringer in accordance with claim 9, wherein the plurality of layers of material have a first structural configuration, and the at least one crack barrier layer has a second structural configuration different from the first structural configuration.

11. The stringer in accordance with claim 9, wherein the plurality of layers of material are fabricated from a unidirectional carbon fiber material.

12. The stringer in accordance with claim 9, wherein the at least one crack barrier layer is fabricated from a bidirectional carbon fiber material.

13. The stringer in accordance with claim 9, wherein the multi-layer laminate further comprises a detection layer extending across the folded tip region.

14. The stringer in accordance with claim 9, wherein the at least one crack barrier layer comprises a first crack barrier layer and a second crack barrier layer spaced from each other within the multi-layer laminate.

15. The stringer in accordance with claim 9, wherein the plurality of layers of material and the at least one crack barrier layer are aligned coterminously in at least one dimension.

16. A method of forming a composite structure, the method comprising:
forming a multi-layer laminate including a plurality of layers of material and at least one crack barrier layer extending within the plurality of layers of material;
folding the multi-layer laminate to define a first web region and a second web region in a face-to-face relationship, and a folded tip region defined between the first web region and the second web region; and
curing the multi-layer laminate, wherein the at least one crack barrier layer is configured to restrict crack propagation from spreading through the plurality of layers of material in the folded tip region.

17. The method in accordance with claim 16, wherein forming a multi-layer laminate comprises forming the multi-layer laminate from the plurality of layers having a first structural configuration, and the at least one crack barrier layer having a second structural configuration different from the first structural configuration.

18. The method in accordance with claim 16, wherein folding the multi-layer laminate comprises folding the multi-layer laminate to further define, in sequence, a first base region, the first web region, the folded tip region, the second web region, and a second base region, the multi-layer laminate folded such that the first and second web regions are oriented perpendicularly relative to the first and second base regions.

19. The method in accordance with claim 16, wherein forming a multi-layer laminate comprises forming the multi-layer laminate from the plurality of layers fabricated from a unidirectional carbon fiber material, and from the at least one crack barrier layer fabricated from a bidirectional carbon fiber material.

20. The method in accordance with claim 16, wherein forming a multi-layer laminate comprises positioning a detection layer on the multi-layer laminate for extension across the folded tip region when the multi-layer laminate is folded.
